(19) United States
(12) Patent Application Publication
(10) Pub. No.: US 2024/0276529 A1
(43) Pub. Date: Aug. 15, 2024

(54) RESTRICTIONS ON SIDELINK TRANSMISSION PARAMETERS FOR UES

(71) Applicant: QUALCOMM Incorporated, San Diego, CA (US)

(72) Inventors: Le LIU, San Jose, CA (US); Vishnu Vardhan CHETLUR RAVI, San Diego, CA (US); Umesh PHUYAL, San Diego, CA (US); Hong CHENG, Basking Ridge, NJ (US); Kazuki TAKEDA, Minato-ku (JP); Wanshi CHEN, San Diego, CA (US); Masato KITAZOE, Hachiouji-shi (JP); Changhwan PARK, San Diego, CA (US)

(21) Appl. No.: 18/167,068

(22) Filed: Feb. 9, 2023

(51) Int. Cl. H04W 72/51; H04W 72/40

(52) U.S. Cl. CPC H04W 72/51; H04W 72/40

(57) ABSTRACT

Method and apparatus for restrictions on sidelink transmission parameters for UEs. The apparatus receives a configuration of sidelink transmission parameters based on at least one of a height of the UE, a UE service range, or an area of a UE location. The apparatus communicates based on the sidelink transmission parameters and at least one of the height of the UE, the UE service range, or the area of the UE location. The sidelink transmission parameters comprise a height based condition based on a height threshold. The sidelink transmission parameters indicate for the UE to transmit sidelink transmissions using a first restriction to transmit a transport block when the UE height is greater than or equal to the height threshold and to transmit sidelink transmissions using a second message and a second restriction to transmit the transport block when the UE height is below the height threshold.

### TECHNICAL FIELD

The present disclosure relates generally to communication systems, and more particularly, to a configuration for restrictions on sidelink transmission parameters for user equipments (UEs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus receives a configuration of sidelink transmission parameters based on at least one of a height of the UE, a UE service range, or an area of a UE location. The apparatus communicates based on the sidelink transmission parameters and at least one of the height of the UE, the UE service range, or the area of the UE location.

In an aspect of the disclosure, a method, a computer-readable medium, and an apparatus are provided. The apparatus may be a device at a network node. The device may be a processor and/or a modem at a network node or the network node itself. The apparatus configures sidelink transmission parameters based on at least one of a height of a user equipment (UE), a UE service range, or an area of a UE location. The apparatus provides a configuration of the sidelink transmission parameters based on at least one of the height of the UE, the UE service range, or the area of the UE location. The apparatus communicates based on the sidelink transmission parameters and at least one of the height of the UE, the UE service range, or the area of the UE location.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of sidelink transmission parameters.

FIG. 4B is a diagram illustrating an example of sidelink transmission parameters.

FIG. 5A is a diagram illustrating an example of sidelink transmission parameters.

FIG. 5B is a diagram illustrating an example of sidelink transmission parameters.

FIG. 6 is a diagram illustrating an example of sidelink transmission parameters.

FIG. 7 is a diagram illustrating an example of sidelink transmission parameters.

FIG. 8 is a diagram illustrating an example of UAVs in a wireless communication network.

FIG. 9 is a diagram illustrating an example of height based sidelink transmission parameters.

FIG. 10 is a diagram illustrating an example of height based sidelink transmission parameters.

FIG. 11 is a diagram illustrating an example of range based sidelink transmission parameters.

FIG. 12 is a diagram illustrating an example of range based sidelink transmission parameters.

FIG. 13 is a diagram illustrating an example of area or zone based sidelink transmission parameters.

FIG. 14 is a call flow diagram of signaling between a UE and a base station.

FIG. 15 is a flowchart of a method of wireless communication.

FIG. 16 is a diagram illustrating an example of a hardware implementation for an example apparatus and/or network entity.

FIG. 17 is a flowchart of a method of wireless communication.

FIG. 18 is a diagram illustrating an example of a hardware implementation for an example network entity.

FIG. 19 is a diagram illustrating an example of flight path parameters.

### DETAILED DESCRIPTION

In wireless communications congestion control may be utilized to control traffic load on the system or resource pool and to prevent overloading. In some instances, sidelink transmission parameters and channel occupation ratio (CR) limit may be restricted based on a quality of service (QOS) priority and/or channel busy ratio (CBR) range. The CBR may indicate the overall congestion level of physical sidelink shared channel (PSSCH) sub-channels, in sidelink communications, in a resource pool in a period of time. In addition to congestion control, speed-based restriction may be utilized to configure sidelink transmission parameters based on different speeds.

Unmanned aerial vehicles (UAVs), also known as drones, are aircrafts without a human pilot on board. UAVs may comprise sensors, cameras, and other instruments, such as but not limited to a UE. UAVs may fly in the air at different heights, and UAVs that comprise a UE may cause interference to or from other distant UEs due to a line of sight channel. Positioning or the location of UAVs that comprise a UE may be determined based on navigation systems such as but not limited to Global Navigation Satellite System (GNSS), ground facing light detection and ranging (LIDAR), radio assisted detection and ranging (RADAR), sound navigation and ranging (SONAR), imaging capture, depth analysis, or the like. UAVs comprising a UE may connect to a base station or wireless network via a Uu interface. For UAVs comprising a UE that are in a connected state with the base station or the wireless network, the base station may configure the UE of the UAV to report its height via radio resource control (RRC) signaling. In some instances, the reporting of the height of the UE of the UAV may be periodic reporting or trigger-based reporting. However, UAVs that comprise a UE and are on the ground, may cause interference, to a lesser extent than UAVs flying in the air, to or from other distant UEs due to a non-line of sight channel. An issue for UAVs comprising a UE is interference on other UEs based at least on the height of the UAV, the type of traffic transmitted by the UAV, or the location of the UAV.

Aspects presented herein provide a configuration for restriction on sidelink transmission parameters for UAVs comprising a UE. UAVs may have conditions placed on their sidelink transmission capabilities in order to reduce interference to other UEs. At least one advantage of the disclosure is that the configuration of the sidelink transmission parameters may reduce interference to other UEs based on the height of the UE, the UE service range, or the area of a UE location.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

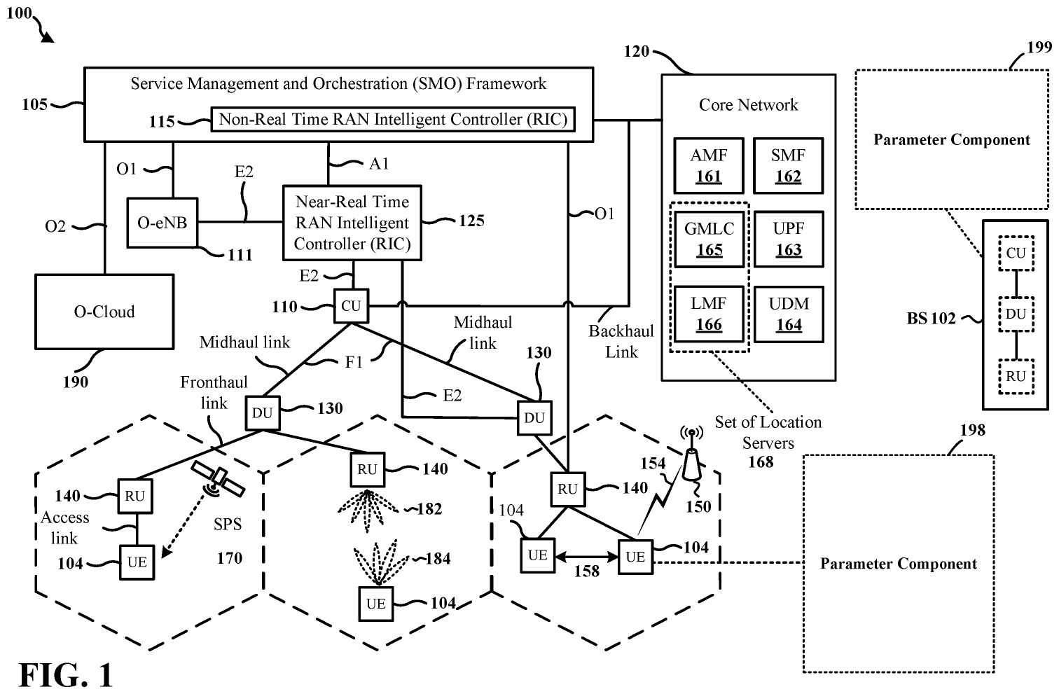

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a parameter component 198 configured to receive a configuration of sidelink transmission parameters based on at least one of a height of the UE, a UE service range, or an area of a UE location; and communicate based on the sidelink transmission parameters and at least one of the height of the UE, the UE service range, or the area of the UE location.

Referring again to FIG. 1, in certain aspects, the base station 102 may comprise a parameter component 199 configured to configure sidelink transmission parameters based on at least one of a height of a UE, a UE service range, or an area of a UE location; provide a configuration of the sidelink transmission parameters based on at least one of the height of the UE, the UE service range, or the area of the UE location; and communicate based on the sidelink transmission parameters and at least one of the height of the UE, the UE service range, or the area of the UE location.

Although the following description may be focused on 5G NR, the concepts described herein may be applicable to other similar areas, such as LTE, LTE-A, CDMA, GSM, and other wireless technologies.

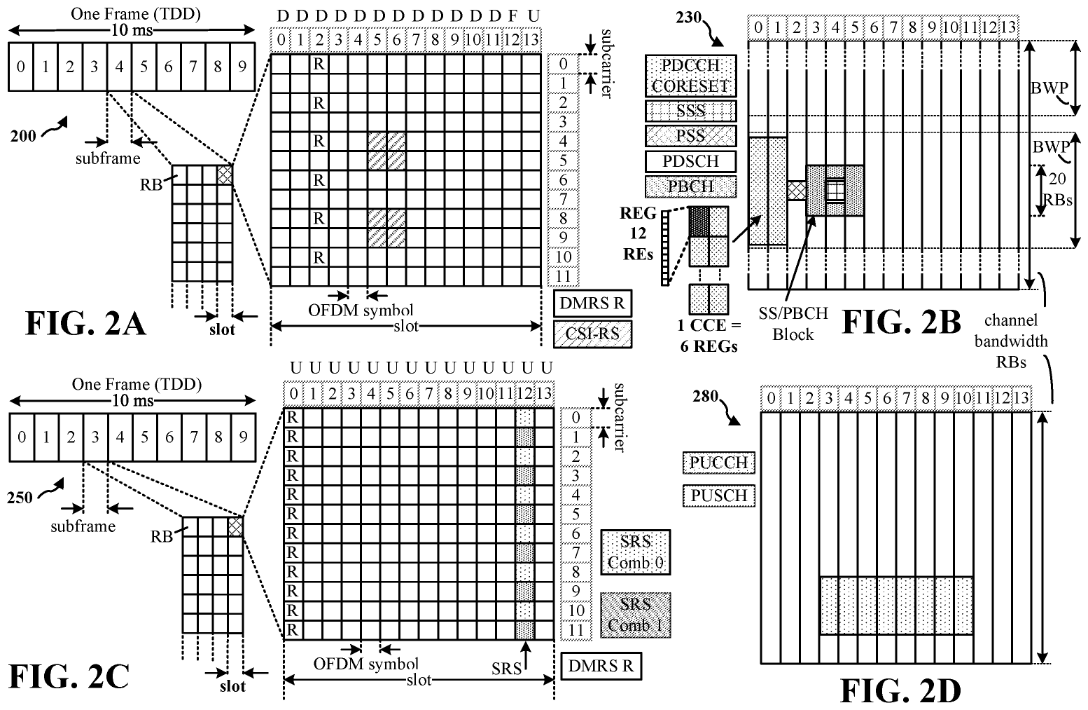

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

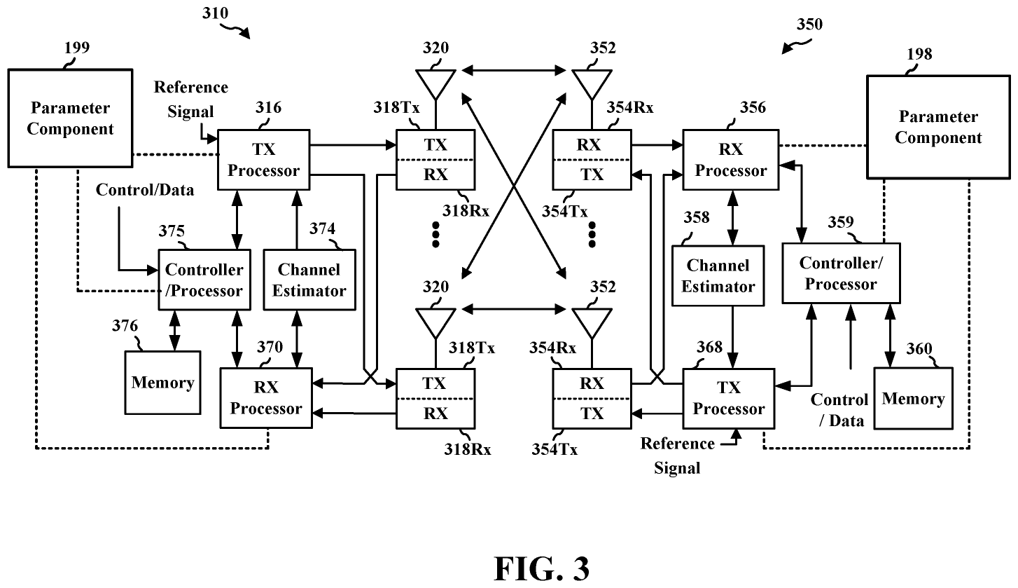

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the parameter component 198 of FIG. 1.

At least one of the TX processor 316, the RX processor 370, and the controller/processor 375 may be configured to perform aspects in connection with the parameter component 199 of FIG. 1.

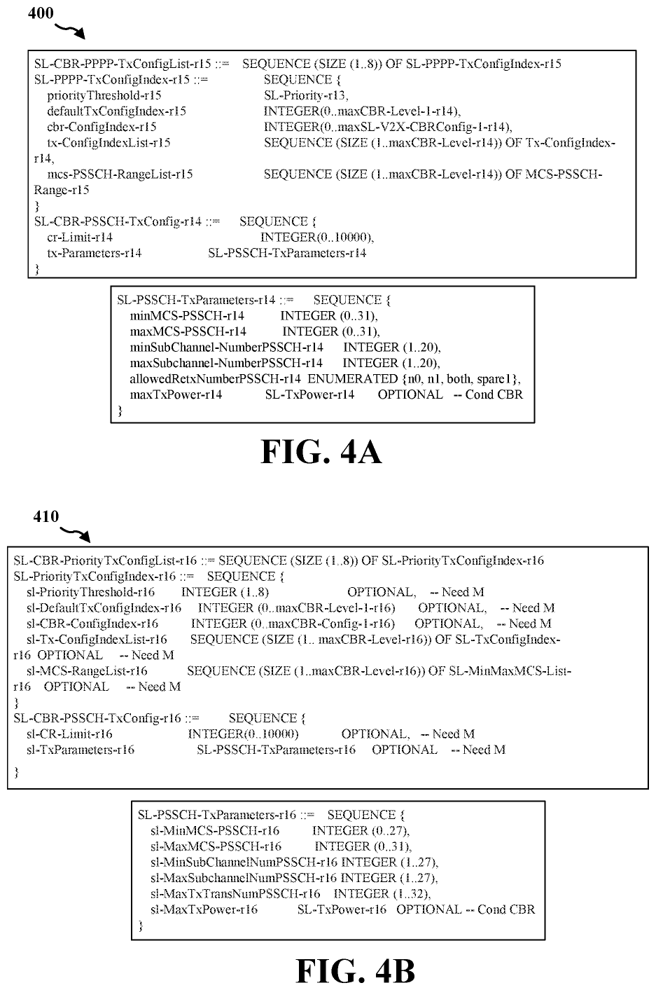

In wireless communications congestion control may be utilized to control traffic load on the system or resource pool and to prevent overloading. In some instances, sidelink transmission parameters and channel occupation ratio (CR) limit may be restricted based on a quality of service (QOS) priority and/or channel busy ratio (CBR) range. The CR may indicate how much of the resources are used by the UE per priority level in a resource pool in a period of time. The CBR may indicate the overall congestion level of physical sidelink shared channel (PSSCH) sub-channels, in sidelink communications, in a resource pool in a period of time. In some wireless communication systems, such as in LTE mode4, sidelink parameters (e.g., SL-CBR-PPP-TxConfigList) may be configured via SIB (e.g., SIB26) or dedicated radio resource control (RRC) signaling, or may be preconfigured (e.g., SL-V2X-Preconfiguration), as shown for example in diagram 400 of FIG. 4A. In some wireless communication systems, such as NR mode2, sidelink parameters (e.g., SL-CBR-PriorityTxConfigList) may be configured via SIB (e.g., SIB12) or dedicated RRC signaling, or may be preconfigured (e.g., SL-PreconfigurationNR), as shown for example in diagram 410 of FIG. 4B.

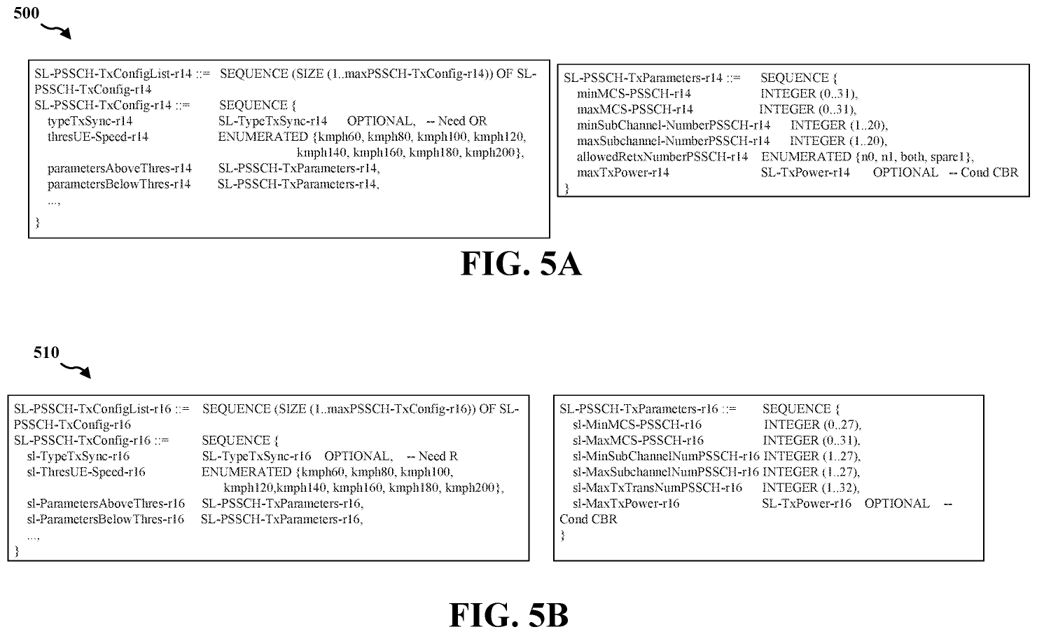

In addition to congestion control, speed-based restriction may be utilized to configure sidelink transmission parameters based on different speeds. For example, in LTE mode4, sidelink parameters (e.g., SL-PSSCH-TxConfigList) may be configured via SIB (e.g., SIB21) or dedicated RRC or preconfigured (e.g., SL-V2X-Preconfiguration), as shown for example in diagram 500 of FIG. 5A. In another example, such as in NR mode2, parameters (e.g., SL-PSSCH-TxConfigList) may be configured via SIB (e.g., SIB12) or dedicated RRC signaling, or may be preconfigured (e.g., SL-PreconfigurationNR), as shown for example in diagram 510 of FIG. 5B.

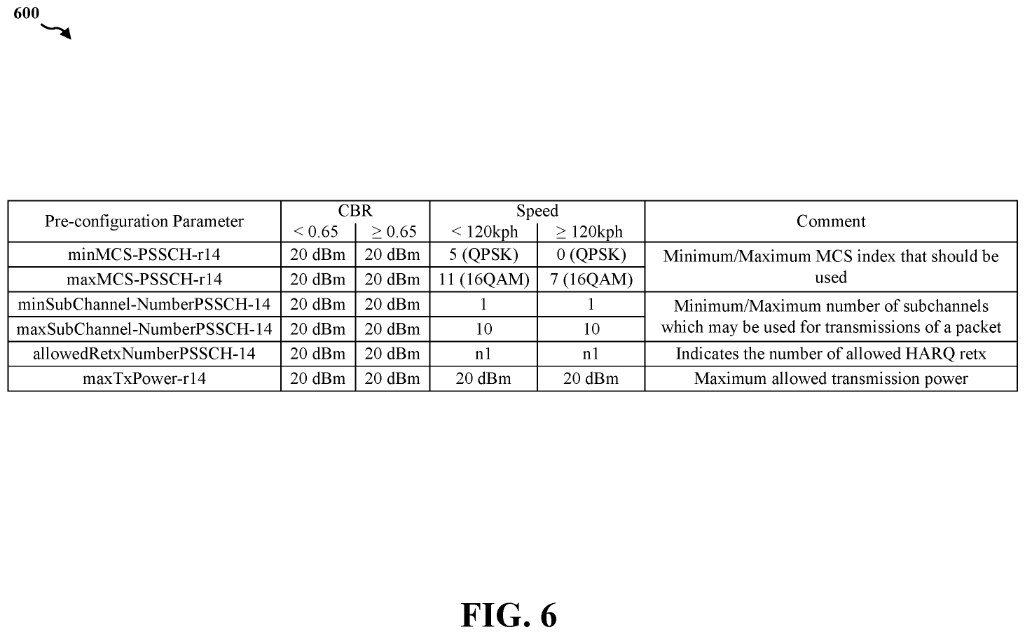

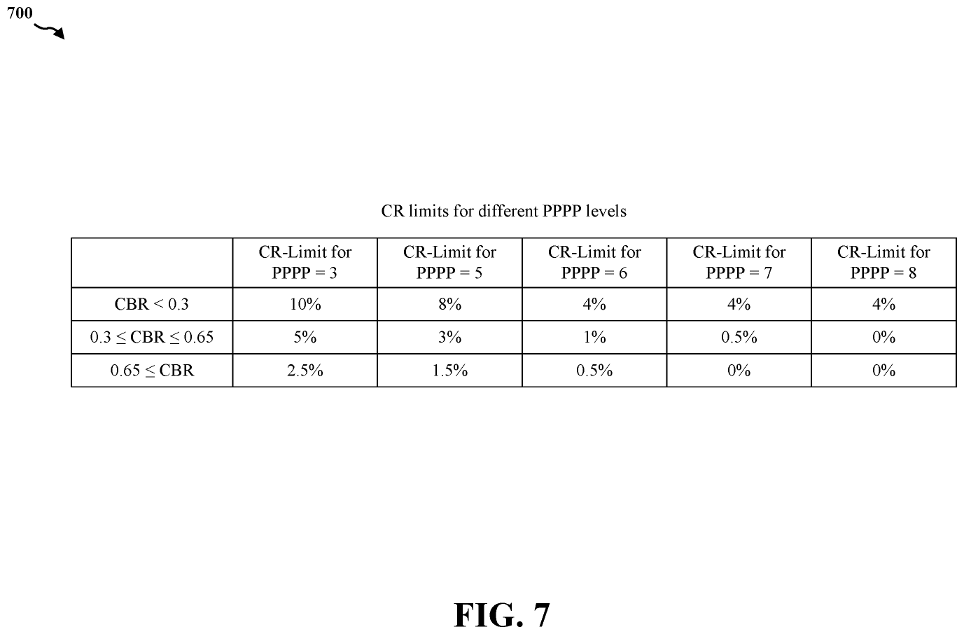

In some instances, sidelink transmission parameters for different speeds and/or CBR levels may be predefined. For example, PSSCH transmission parameters may include MCS, sub-channel number, retransmission number, and/or maximum transmission power, as shown for example in diagram 600 of FIG. 6. Diagram 700 of FIG. 7 provides an example of different priority levels configured with different limits (e.g., CR_limit) such that higher priority messages may have more opportunities and resources to be transmitted. In some instances, if the CR is higher than a threshold (e.g., CR_limit), then the UE may drop some transmissions. The UE may determine how to meet the thresholds or limits, as well as the dropping of transmissions.

UAVs, also known as drones, are aircrafts without a human pilot on board. UAVs may be operated remotely or autonomously based on a set of instructions, and may comprise sensors, cameras, and other instruments, such as but not limited to a UE. UAVs are used for various applications such as military surveillance, wildlife conservation, disaster relief, delivery services, and aerial photography. They offer advantages such as the ability to reach hard-to-access locations. UAVs may reach different heights that terrestrial UEs are not able to access. UAVs may fly in the air at different heights, and UAVs that comprise a UE may cause interference to or from other distant UEs due to a line of sight channel. However, UAVs that comprise a UE and are on the ground, may cause interference, to a lesser extent than UAVs flying in the air, to or from other distant UEs due to a non-line of sight channel.

UAVs comprising a UE may also comprise new types of traffic. For example, UAVs may transmit a broadcast remote identifier (BRID) that is broadcasted for safety and security to law enforcement or other agencies on the ground. For example, the BRID may comprise a small packet size (e.g., approximately 0.25 kbytes). BRID may not have a requirement of low latency with a large periodicity (e.g., 1 second), or may comprise a maximum broadcast range (e.g., 1-2 km). In another example, UAVs may also transmit detect and avoid (DAA) signals which broadcast mobility information, positioning, heading, or the like. DAA may comprise a small-to-medium packet size (e.g., approximately 0.25-1 kbytes), may comprise a low latency with a small periodicity (e.g., approximately 20-100 ms), or may be utilized for proximate communications (e.g., approximately 0.5-1 km). However, issues may be present for UAVs comprising a UE with regards to minimizing or controlling interference based at least on the height of the UAV, the type of traffic transmitted by the UAV, or the location of the UAV.

Aspects presented herein provide a configuration for restriction on sidelink transmission parameters for UEs. For example, UEs (e.g., UAVs) may have conditions placed on their sidelink transmission capabilities in order to reduce interference to other UEs. The UE may receive a configuration of sidelink transmission parameters that may modify or alter the sidelink transmission capabilities of the UE based on at least one of a height of the UE, a UE service range, or an area of a UE location. At least one advantage of the disclosure is that the configuration of the sidelink transmission parameters may reduce interference to other UEs based on the height of the UE, the UE service range, or the area of a UE location.

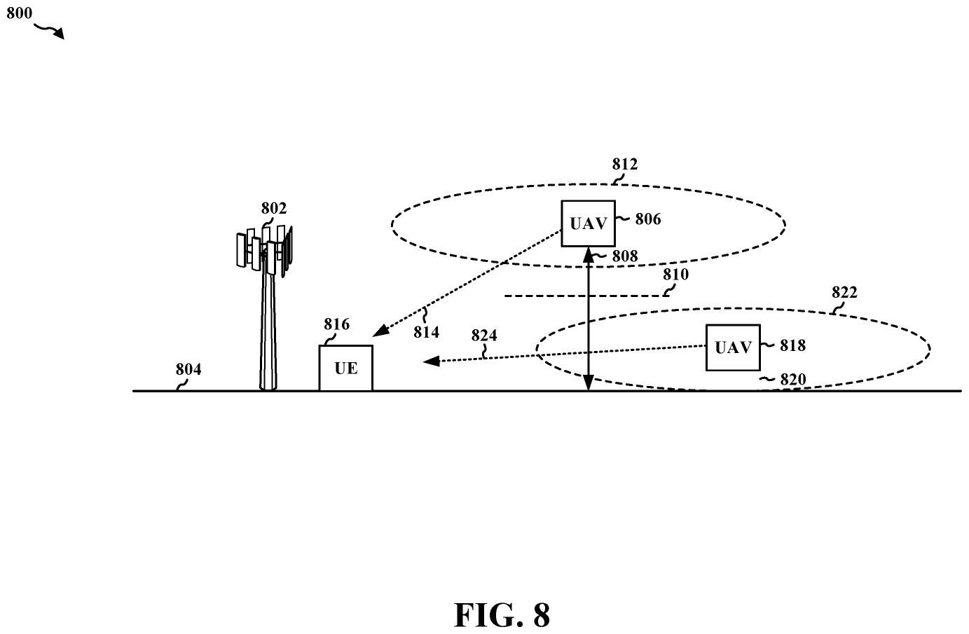

FIG. 8 illustrates an example of UAVs in a wireless communication network. The diagram 800 comprises a first UAV 806 comprising a UE. The UAV 806 may communicate with a base station 802 that is located on a ground level 804. The UAV 806 may be flying in the air such that the UAV is at a height, elevation, or altitude 808 above the ground level 804. The UAV 806 may be flying at the height 808 which is greater than a height threshold 810, where the height threshold 810 may be based on a distance from the ground level 804. Transmissions 814 from the UAV 806 may cause interference with distant UEs (e.g., UE 816) due to its height 808. The UAV 806 may also be within an area 812. In some instances, a UAV 818 may be flying at a height 820 that is less than the height threshold 810. In such instances, transmissions 824 from the UAV 818 may cause less interference with distant UEs (e.g., UE 816), than that of UAV 806, due to the UAV 818 being at the height 820 that is less than the height threshold 810. The UAV 818 may also be within an area 822.

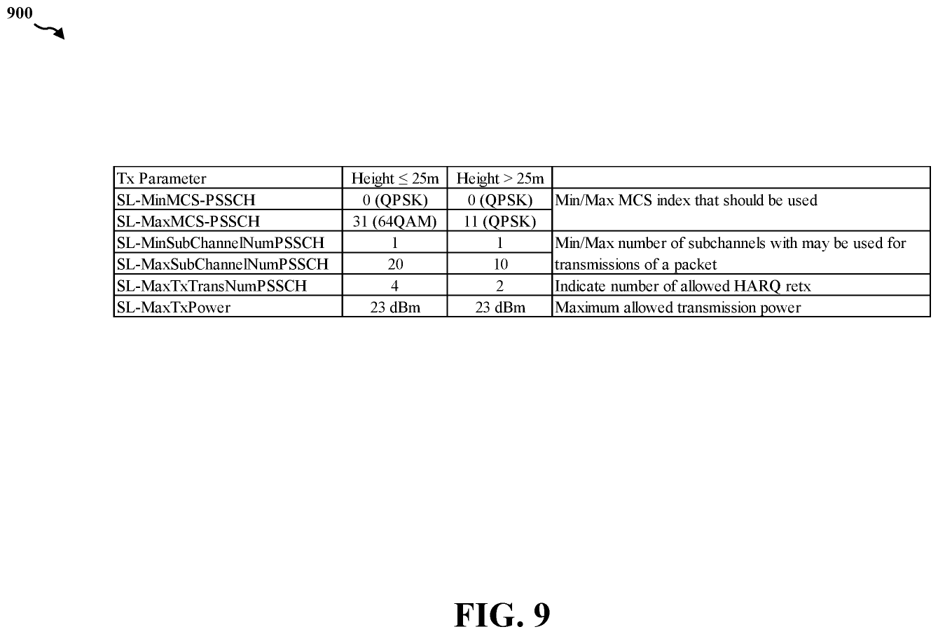

In view of the potential different heights that UAVs may travel, sidelink transmission parameters may be configured to include height based restrictions or conditions. For example, height-based restrictions/conditions may be configured or preconfigured for sidelink transmission parameters. In instances where a UAV is flying in the air, a PSSCH may be restricted or conditioned to transmit packets with a short message with a small transport block (e.g., BRID, DAA) using a small number of subchannels and limited HARQ retransmissions. The height based restrictions may allow for a reduction in interference for line-of-sight channels. In instances where the UAV is on the ground or flying in the air at a height low to the ground, a PSSCH may be configured to transmit long messages and large transport blocks, using a large number of subchannels and HARQ retransmissions. UAVs that are on the ground or flying in the air at a height low to the ground may act like terrestrial UEs and may not result in high interference in comparison to UAVs in the air. Diagram 900 of FIG. 9 provides an example height based sidelink transmission parameters for UAVs, where a height threshold is 25 m. The height threshold of 25 m is a non-limiting example, such that in some aspects, the height threshold may be greater than or lesser than 25 m.

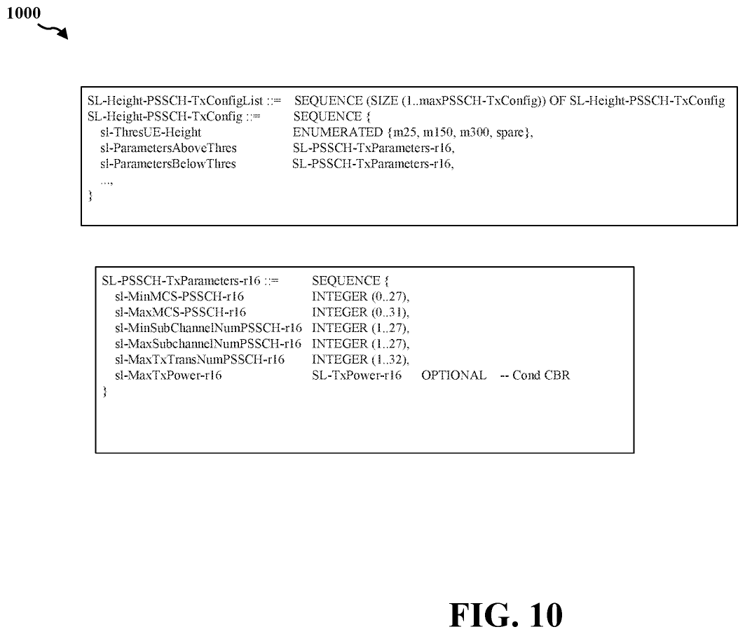

In some aspects, the height threshold may be a height relative to sea level, or a height relative to a reference point (e.g., ground level, a network entity, or a target UE). The height threshold may be used to restrict or control at least one of a range of MCS for a given MCS table for PSSCH supported within the resource pool, a range of a number of sub-channels used for PSSCH, an upper bound of number of transmissions or retransmissions for PSSCH, or an upper bound of TX power for PSSCH and PSCCH, as shown for example in diagram 1000 of FIG. 10. In some instances, the height based restrictions or conditions may indicate an absolute height threshold. In some instances, the height based restrictions or conditions may indicate transmission parameters for a UE speed above or below the height threshold.

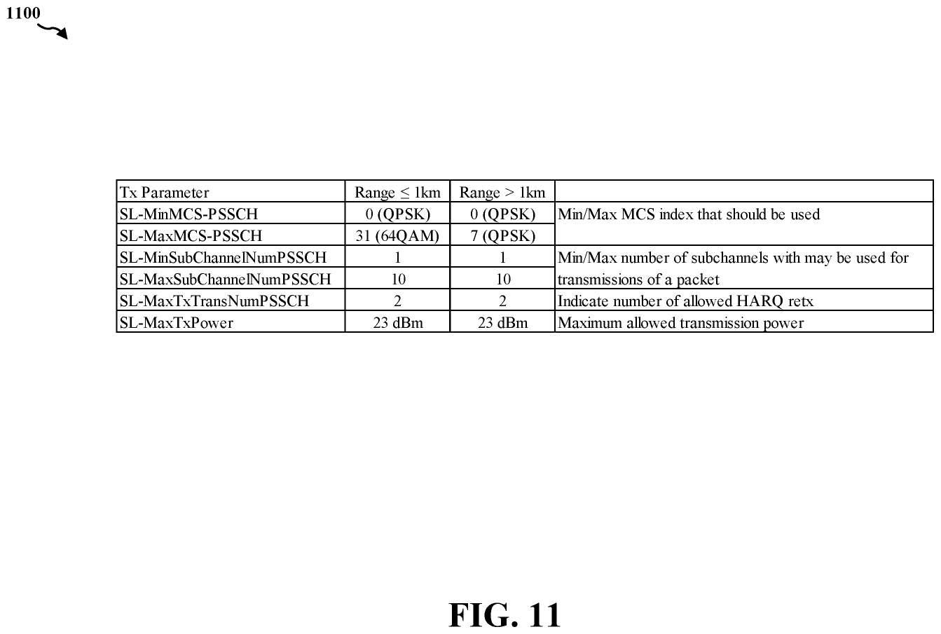

In some aspects, sidelink transmission parameters may be configured to include range based restrictions or conditions. For example, range-based restrictions/conditions may be configured or preconfigured for sidelink transmission parameters. The range parameter may be associated with traffic or a QoS flow, e.g., sidelink range configuration (e.g., SL-QoS-profile), which may be the communication range or distance required for broadcast or groupcast traffic if needed. In some aspects, such as for UAV BRID transmissions, the broadcast range requirement may be larger than 1 km, which may utilize a higher transmission power and/or larger number of blind retransmission. However, data packets for BRID comprise small transport blocks with low MCS. In some aspects, such as for UAV DAA transmissions, the broadcast range requirement may be less than 1 km, which may allow for a reduced transmission power and/or less number of blind retransmission, than that of BRID transmissions. Data packets for DAA may comprise variable transport blocks with a low to medium MCS. Diagram 1100 of FIG. 11 provides an example of range based sidelink transmission parameters for UAVs, where a range threshold is 1 km. The range threshold of 1 km is a non-limiting example, such that in some aspects, the range threshold may be greater than or lesser than 1 km.

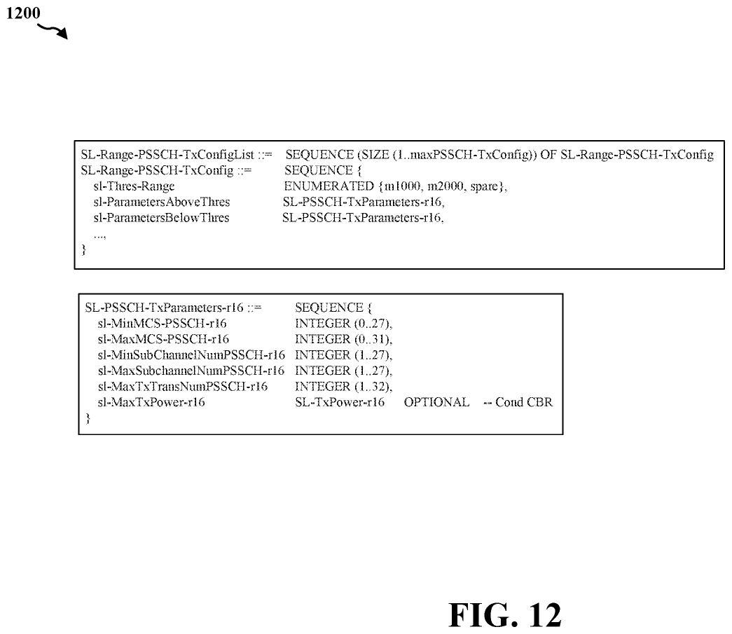

In some aspects, the range threshold may comprise a three-dimensional range for different traffic associated with a QoS flow. The range threshold may be used to restrict or control at least one of a range of MCS for a given MCS table for PSSCH supported within the resource pool, a range of a number of sub-channels used for PSSCH, an upper bound of number of transmissions or retransmissions for PSSCH, or an upper bound of transmission power for PSSCH and/or PSCCH, as shown for example in diagram 1200 of FIG. 12. In some instances, the range based restrictions or conditions may indicate a range threshold for the QoS flow. In some instances, the range based restrictions or conditions may indicate transmission parameters for a UAV speed above or below the range threshold.

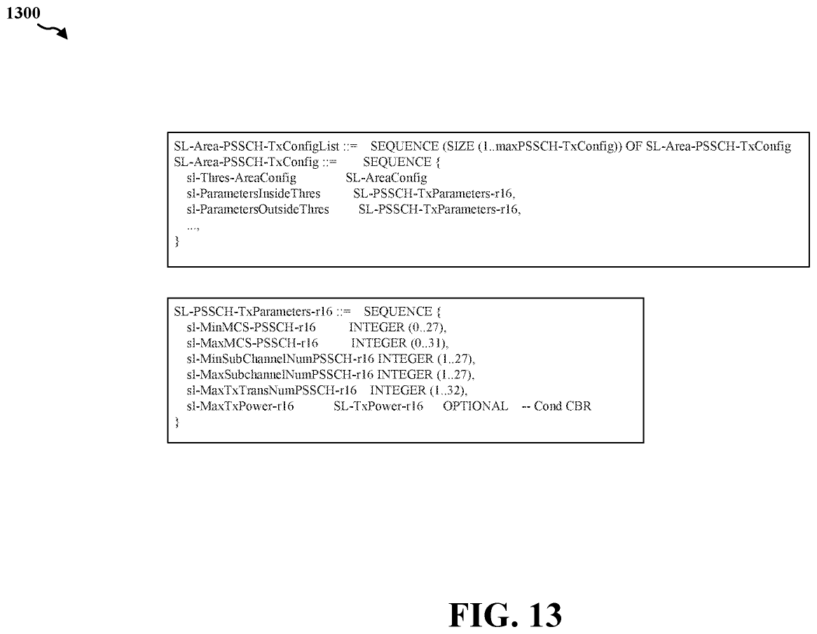

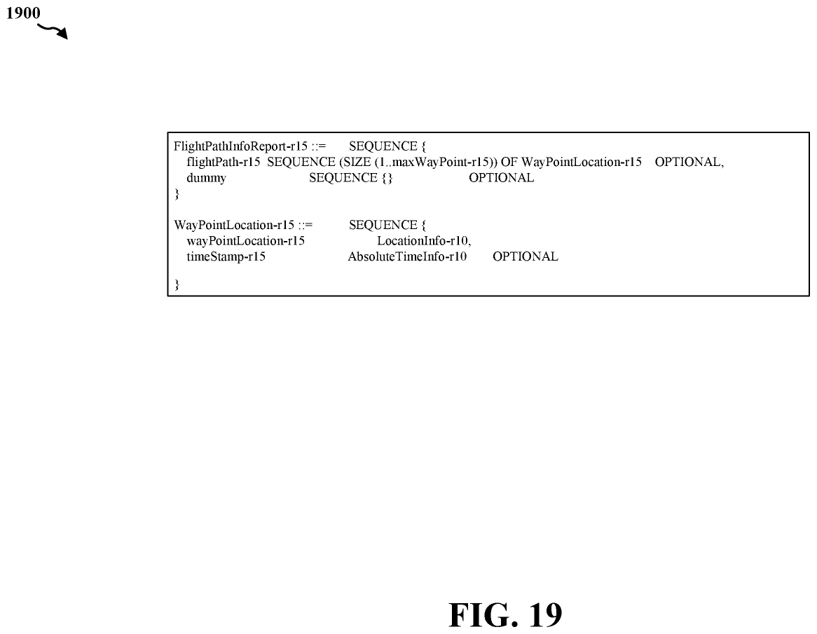

In some aspects, sidelink transmission parameters may be configured to include area or zone based restrictions or conditions. For example, area or zone based restrictions or conditions may be configured or preconfigured for sidelink transmission parameters. Some examples of area or zone based restrictions may comprise airports and/or other flight restricted airspace, which may be indicated to the UE of the UAV by the network or an unmanned aircraft system. In some aspects, the area or zone parameter may be comprised of a geographic area or a two-dimensional or a three-dimensional zone. In instances where the UAV is flying within the specific area or zone, the UAV may use a reduced or limited transmission power or a reduced or limited amount of subchannels. The area or zone threshold may be used to restrict or control at least one of a range of MCS for a given MCS table for PSSCH supported within the resource pool, a range of number of sub-channels used for PSSCH, an upper bound of a number of transmissions or retransmissions for PSSCH, or an upper bound of transmission power for PSSCH or PSCCH, as shown for example in diagram 1300 of FIG. 13. In some instances, the area or zone based restrictions or conditions may indicate a geographic area threshold, which may comprise a geographic region or a list of zone IDs or cell IDs within the area. In some instances, the area or zone based restrictions or conditions may indicate transmission parameters for a UAV speed inside or outside of the area or zone threshold. In some aspects, the UAV may comprise a flight plan having an expected positioning of a UAV that may be provided to the network in advance. The flight plan may be a known or existing flight path that limits or defines the positions that UAVs (e.g., with or without a UE) are expected to adhere to for the duration of the flight path. An expected location at a time stamp may be based on the flight path reported by the UE of the UAV. In some aspects, the UE of the UAV may report the flight path via RRC signaling. The UE of the UAV may report the flight path including way point for different times (e.g., per time stamp), as shown for example in diagram 1900 of FIG. 19. If information related to the flight path is provided, the UE of the UAV may be configured to transmit data at a different rate in instances where the UAV deviates from the flight path. In such instances, the UE of the UAV may be configured to transmit DAA at an increased rate. For example, in comparison with a UAV remaining on the scheduled flight path, the UAV having the UE that is deviating from the flight path may send more traffic for DAA with corresponding related transmission parameters.

The sidelink transmission parameters for different height, range, or area may be configured via SIB or dedicated RRC (if in coverage) or configured or preconfigured per UE per carrier. The carrier may comprise carrier frequencies of existing sidelink communications. In some aspects, the carrier may comprise carrier frequencies that may be dedicated for UAV sidelink communication. In some aspects, one or more restrictions or conditions may be configured or preconfigured, such as a combination of CBR, speed, height, range, and/or area. In instances of multiple restrictions or conditions, the multiple restrictions or conditions may be configured to satisfy all the restrictions on sidelink transmission parameters, or may be configured to select some of restrictions based on a priority between the multiple restrictions or conditions. The manner in which the selection of the priority between the multiple restrictions or conditions may be configured or preconfigured at the UAV comprising the UE.

In some aspects, such as for unicast, group and broadcast, the sidelink transmission parameters may be configured in a different manner. For example, a DAA may comprise a unicast DAA and a broadcast DAA. In some aspects, a maximum MCS, a number of subchannels, or retransmissions for HARQ-ACK feedback for unicast DAA may be larger than that of broadcast DAA. In some aspects, one or multiple thresholds based on height, range, or area may be supported by configuring or preconfiguring a list of sidelink transmission configurations. The list of sidelink transmission configurations may be separately configured for UA Vs and non-UAVs. In some aspects, one list of sidelink transmission configurations may be shared for UAVs and non-UAVs, with some threshold parameters only for UAV.

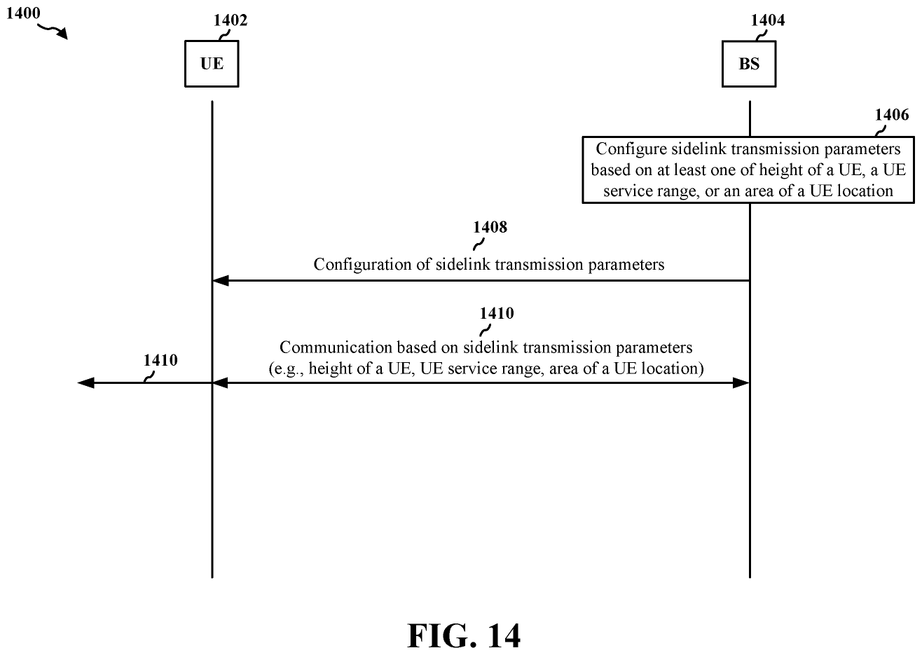

FIG. 14 is a call flow diagram 1400 of signaling between a UE 1402 and a base station 1404. The base station 1404 may be configured to provide at least one cell. The UE 1402 may be configured to communicate with the base station 1404. For example, in the context of FIG. 1, the base station 1404 may correspond to base station 102 and the UE 1402 may correspond to at least UE 104. In another example, in the context of FIG. 3, the base station 1404 may correspond to base station 310 and the UE 1402 may correspond to UE 350.

At 1406, the base station 1404 may configure sidelink transmission parameters based on at least one of a height of a UE, a UE service range, or an area of a UE location. In some aspects, the sidelink transmission parameters may comprise a height based condition based on a height threshold. The sidelink transmission parameters may indicate for the UE to transmit sidelink transmissions using a first restriction in the sidelink transmission parameters to transmit a transport block when the height of the UE is greater than or equal to the height threshold. The sidelink transmission parameters may indicate for the UE to transmit sidelink transmissions using a second message and a second restriction in the sidelink transmission parameters to transmit the transport block when the height of the UE is below the height threshold. In some aspects, the sidelink transmissions comprise at least a broadcast remote identifier (BRID) or a detect and avoid (DAA) signal. In some aspects, the height threshold may be based at least on one of a sea level, a ground level, a height of a serving cell, or a reference point. For example, the height threshold based on the sea level may be utilized in instances where at least the UE is located in an area that is within the vicinity of a sea, such that the sea level may be utilized for the height threshold. In some instances, the sea level may be utilized for the height threshold where at least the UE is located in an area that is beyond the sea. In some aspects, the height of the serving cell may be based on the height of one or more antenna panels above the ground surface or ground level. In yet some instances, the height threshold may be based on the reference point that may be predetermined or configurable. In some aspects, the height based condition may be associated with at least one of a range of modulation and coding scheme (MCS) for the sidelink transmissions, a range of a number of subchannels used for the sidelink transmissions, an upper bound of sidelink retransmissions, or an upper bound of sidelink transmission power for the sidelink transmissions. In some aspects, the sidelink transmission parameters may comprise a range based condition based on a range threshold. The sidelink transmission parameters may indicate for the UE to transmit sidelink transmissions using a first restriction in the sidelink transmission parameters to transmit a transport block for a UE service when the UE service range requirement is greater than or equal to the range threshold. The sidelink transmission parameters may indicate for the UE to transmit the sidelink transmissions using a second message and a second restriction in the sidelink transmission parameters to transmit the transport block when the UE service range requirement is below the range threshold. In some aspects, the range based condition may comprise limitations to at least one of a range of MCS for sidelink transmissions, a range of a number of subchannels used for sidelink transmissions, an upper bound of a number of sidelink retransmissions, or an upper bound of sidelink transmission power for the sidelink transmissions. In some aspects, the sidelink transmission parameters may comprise a geographic area based condition. The sidelink transmission parameters may indicate for the UE to transmit sidelink transmissions using a first restriction in the sidelink transmission parameters to transmit a transport block for a UE service when the UE location is within the geographic area. The sidelink transmission parameters may indicate for the UE to transmit the sidelink transmissions using a second message and a second restriction in the sidelink transmission parameters to transmit the transport block when the UE location is outside the geographic area. In some aspects, the geographic area based condition comprise limitations to at least one of a range of MCS for sidelink transmissions, a range of a number of subchannels used for the sidelink transmissions, an upper bound of a number of sidelink retransmissions, or an upper bound for sidelink transmission power.

At 1408, the UE 1402 may receive the configuration for sidelink transmission parameters. The sidelink transmission parameters may be based on at least one of the height of the UE, the UE service range, or the area of a UE location. The UE 1402 may receive the configuration for the sidelink transmission parameters from the base station 1404.

At 1410, the UE 1402 the UE may communicate based on the sidelink transmission parameters. The UE may communicate based on the sidelink transmission parameters and at least one of the height of the UE, the UE service range, or the area of the UE location. The UE may communicate with at least the base station 1404 or another UE (e.g., not shown) based on the sidelink transmission parameters and at least one of the height of the UE, the UE service range, or the area of the UE location.

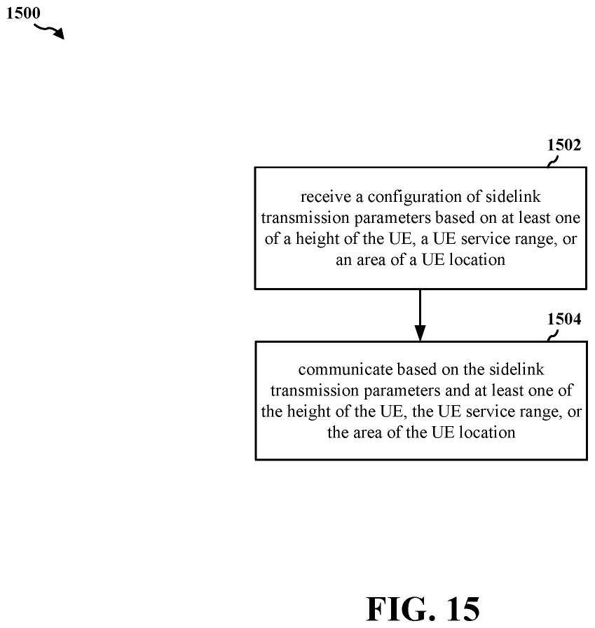

FIG. 15 is a flowchart 1500 of a method of wireless communication. The method may be performed by a UE (e.g., the UE 104; the apparatus 1604). One or more of the illustrated operations may be omitted, transposed, or contemporaneous. The method may configure a UE (e.g., UAV) with restrictions on sidelink transmission parameters to minimize interference with other UEs.

At 1502, the UE may receive a configuration for sidelink transmission parameters. For example, 1502 may be performed by parameter component 198 of apparatus 1604. The sidelink transmission parameters may be based on at least one of a height of the UE, a UE service range, or an area of a UE location. In some aspects, the sidelink transmission parameters may comprise a height based condition based on a height threshold. The sidelink transmission parameters may indicate for the UE to transmit sidelink transmissions using a first restriction in the sidelink transmission parameters to transmit a transport block when the height of the UE is greater than or equal to the height threshold. The sidelink transmission parameters may indicate for the UE to transmit sidelink transmissions using a second message and a second restriction in the sidelink transmission parameters to transmit the transport block when the height of the UE is below the height threshold. In some aspects, the sidelink transmissions comprise at least a broadcast remote identifier (BRID) or a detect and avoid (DAA) signal. In some aspects, the height threshold may be based at least on one of a sea level, a ground level, a height of a serving cell, or a reference point. For example, the height threshold based on the sea level may be utilized in instances where at least the UE is located in an area that is within the vicinity of a sea, such that the sea level may be utilized for the height threshold. In some instances, the sea level may be utilized for the height threshold where at least the UE is located in an area that is beyond the sea. In some aspects, the height of the serving cell may be based on the height of one or more antenna panels above the ground surface or ground level. In yet some instances, the height threshold may be based on the reference point that may be predetermined or configurable. In some aspects, the height based condition may be associated with at least one of a range of modulation and coding scheme (MCS) for the sidelink transmissions, a range of a number of subchannels used for the sidelink transmissions, an upper bound of sidelink retransmissions, or an upper bound of sidelink transmission power for the sidelink transmissions. In some aspects, the sidelink transmission parameters may comprise a range based condition based on a range threshold. The sidelink transmission parameters may indicate for the UE to transmit sidelink transmissions using a first restriction in the sidelink transmission parameters to transmit a transport block for a UE service when the UE service range requirement is greater than or equal to the range threshold. The sidelink transmission parameters may indicate for the UE to transmit the sidelink transmissions using a second message and a second restriction in the sidelink transmission parameters to transmit the transport block when the UE service range requirement is below the range threshold. In some aspects, the range based condition may comprise limitations to at least one of a range of MCS for sidelink transmissions, a range of a number of subchannels used for sidelink transmissions, an upper bound of a number of sidelink retransmissions, or an upper bound of sidelink transmission power for the sidelink transmissions. In some aspects, the sidelink transmission parameters may comprise a geographic area based condition. The sidelink transmission parameters may indicate for the UE to transmit sidelink transmissions using a first restriction in the sidelink transmission parameters to transmit a transport block for a UE service when the UE location is within the geographic area. The sidelink transmission parameters may indicate for the UE to transmit the sidelink transmissions using a second message and a second restriction in the sidelink transmission parameters to transmit the transport block when the UE location is outside the geographic area. In some aspects, the geographic area based condition comprise limitations to at least one of a range of MCS for sidelink transmissions, a range of a number of subchannels used for the sidelink transmissions, an upper bound of a number of sidelink retransmissions, or an upper bound for sidelink transmission power.

At 1504, the UE may communicate based on the sidelink transmission parameters. For example, 1504 may be performed by parameter component 198 of apparatus 1604. The UE may communicate based on the sidelink transmission parameters and at least one of the height of the UE, the UE service range, or the area of the UE location. The UE may communicate with at least a network entity based on the sidelink transmission parameters and at least one of the height of the UE, the UE service range, or the area of the UE location.

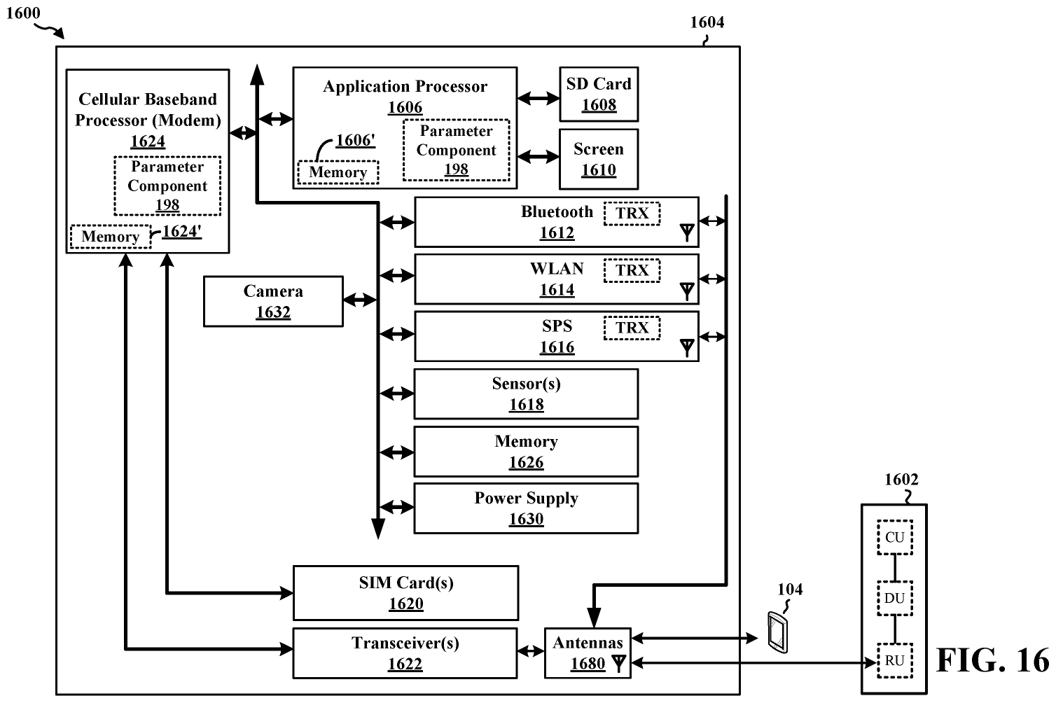

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed supra, the component 198 is configured to receive a configuration of sidelink transmission parameters based on at least one of a height of the UE, a UE service range, or an area of a UE location; and communicate based on the sidelink transmission parameters and at least one of the height of the UE, the UE service range, or the area of the UE location. The component 198 may be within the cellular baseband processor 1624, the application processor 1606, or both the cellular baseband processor 1624 and the application processor 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for receiving a configuration of sidelink transmission parameters based on at least one of a height of the UE, a UE service range, or an area of a UE location. The apparatus includes means for communicating based on the sidelink transmission parameters and at least one of the height of the UE, the UE service range, or the area of the UE location. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

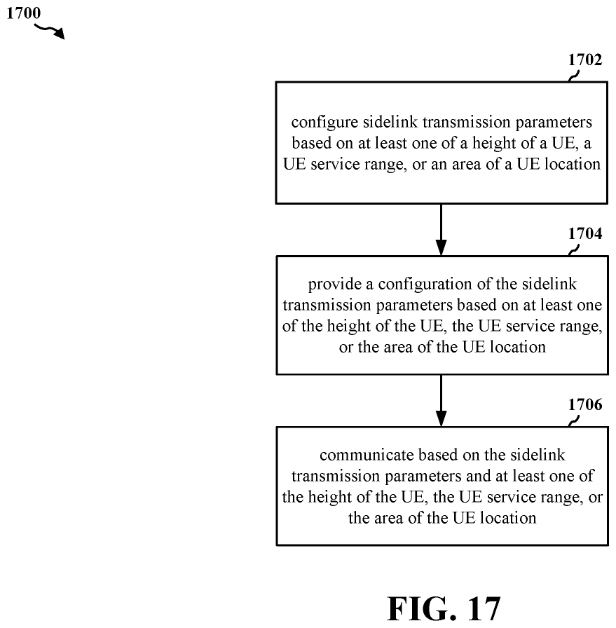

FIG. 17 is a flowchart 1700 of a method of wireless communication. The method may be performed by a base station (e.g., the base station 102; the network entity 1802. One or more of the illustrated operations may be omitted, transposed, or contemporaneous. The method may configure a UE (e.g., UAV) with restrictions on sidelink transmission parameters to minimize interference with other UEs.

At 1702, the base station may configure sidelink transmission parameters. For example, 1702 may be performed by parameter component 199 of network entity 1802. The sidelink transmission parameters may be based on at least one of a height of the UE, a UE service range, or an area of a UE location. In some aspects, the sidelink transmission parameters may comprise a height based condition based on a height threshold. The sidelink transmission parameters may indicate for the UE to transmit sidelink transmissions using a first restriction in the sidelink transmission parameters to transmit a transport block when the height of the UE is greater than or equal to the height threshold. The sidelink transmission parameters may indicate for the UE to transmit sidelink transmissions using a second message and a second restriction in the sidelink transmission parameters to transmit the transport block when the height of the UE is below the height threshold. In some aspects, the sidelink transmissions comprise at least a broadcast remote identifier (BRID) or a detect and avoid (DAA) signal. In some aspects, the height threshold may be based at least on one of a sea level, a height of a serving cell, or a reference point. For example, the height threshold based on the sea level may be utilized in instances where at least the UE is located in an area that is within the vicinity of a sea, such that the sea level may be utilized for the height threshold. In some instances, the sea level may be utilized for the height threshold where at least the UE is located in an area that is beyond the sea. In some aspects, the height of the serving cell may be based on the height of one or more antenna panels above the ground surface or ground level. In yet some instances, the height threshold may be based on the reference point that may be predetermined or configurable. In some aspects, the height based condition may be associated with at least one of a range of modulation and coding scheme (MCS) for the sidelink transmissions, a range of a number of subchannels used for the sidelink transmissions, an upper bound of sidelink retransmissions, or an upper bound of sidelink transmission power for the sidelink transmissions. In some aspects, the sidelink transmission parameters may comprise a range based condition based on a range threshold. The sidelink transmission parameters may indicate for the UE to transmit sidelink transmissions using a first restriction in the sidelink transmission parameters to transmit a transport block for a UE service when the UE service range requirement is greater than or equal to the range threshold. The sidelink transmission parameters may indicate for the UE to transmit the sidelink transmissions using a second message and a second restriction in the sidelink transmission parameters to transmit the transport block when the UE service range requirement is below the range threshold. In some aspects, the range based condition may comprise limitations to at least one of a range of MCS for sidelink transmissions, a range of a number of subchannels used for sidelink transmissions, an upper bound of a number of sidelink retransmissions, or an upper bound of sidelink transmission power for the sidelink transmissions. In some aspects, the sidelink transmission parameters may comprise a geographic area based condition. The sidelink transmission parameters may indicate for the UE to transmit sidelink transmissions using a first restriction in the sidelink transmission parameters to transmit a transport block for a UE service when the UE location is within the geographic area. The sidelink transmission parameters may indicate for the UE to transmit the sidelink transmissions using a second message and a second restriction in the sidelink transmission parameters to transmit the transport block when the UE location is outside the geographic area. In some aspects, the geographic area based condition comprise limitations to at least one of a range of MCS for sidelink transmissions, a range of a number of subchannels used for the sidelink transmissions, an upper bound of a number of sidelink retransmissions, or an upper bound for sidelink transmission power.

At 1704, the base station may provide a configuration of the sidelink transmission parameters based on at least one of the height of the UE, the UE service range, or the area of the UE location. For example, 1704 may be performed by parameter component 199 of network entity 1802. The base station may provide, to the UE, the configuration of the sidelink transmission parameters based on at least one of the height of the UE, the UE service range, or the area of the UE location.

At 1706, the base station may communicate based on the sidelink transmission parameters. For example, 1706 may be performed by parameter component 199 of network entity 1802. The base station may communicate based on the sidelink transmission parameters and at least one of the height of the UE, the UE service range, or the area of the UE location. The base station may communicate with UE based on the sidelink transmission parameters and at least one of the height of the UE, the UE service range, or the area of the UE location.

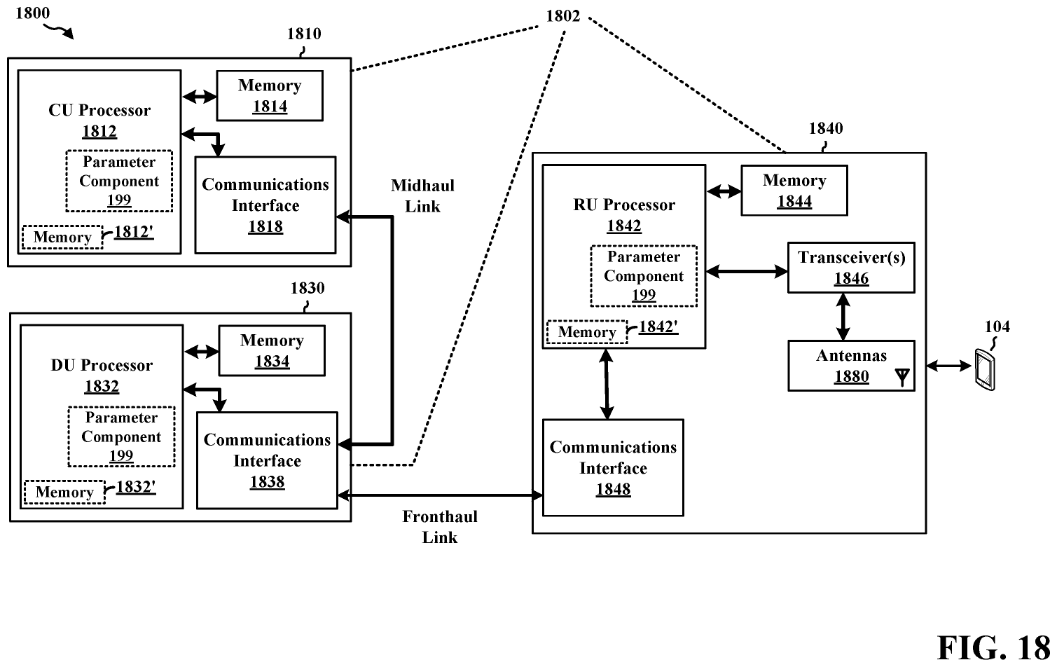

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to configure sidelink transmission parameters based on at least one of a height of a UE, a UE service range, or an area of a UE location; provide a configuration of the sidelink transmission parameters based on at least one of the height of the UE, the UE service range, or the area of the UE location; and communicate based on the sidelink transmission parameters and at least one of the height of the UE, the UE service range, or the area of the UE location. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for configuring sidelink transmission parameters based on at least one of a height of a UE, a UE service range, or an area of a UE location. The network entity includes means for providing a configuration of the sidelink transmission parameters based on at least one of the height of the UE, the UE service range, or the area of the UE location. The network entity includes means for communicating based on the sidelink transmission parameters and at least one of the height of the UE, the UE service range, or the area of the UE location. The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

Aspects presented herein provide a configuration for restriction on sidelink transmission parameters for UEs. For example, UAVs comprising a UE may have conditions placed on their sidelink transmission capabilities in order to reduce interference to other UEs. The UE may receive a configuration of sidelink transmission parameters that may modify or alter the sidelink transmission capabilities of the UE of the UAV based on at least one of a height of the UE, a UE service range, or an area of a UE location. At least one advantage of the disclosure is that the configuration of the sidelink transmission parameters may reduce interference to other UEs based on the height of the UE, the UE service range, or the area of a UE location.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE comprising receiving a configuration of sidelink transmission parameters based on at least one of a height of the UE, a UE service range, or an area of a UE location; and communicating based on the sidelink transmission parameters and at least one of the height of the UE, the UE service range, or the area of the UE location.
Aspect 2 is the method of aspect 1, further includes that the sidelink transmission parameters comprise a height based condition based on a height threshold, wherein the sidelink transmission parameters indicate for the UE to transmit sidelink transmissions using a first restriction in the sidelink transmission parameters to transmit a transport block when the height of the UE is greater than or equal to the height threshold and to transmit the sidelink transmissions using a second message and a second restriction in the sidelink transmission parameters to transmit the transport block when the height of the UE is below the height threshold.
Aspect 3 is the method of any of aspects 1 and 2, further includes that the sidelink transmissions comprise at least a BRID or a DAA signal.
Aspect 4 is the method of any of aspects 1-3, further includes that the height threshold is based at least on one of a sea level, a ground level, a height of a serving cell, or a reference point.
Aspect 5 is the method of any of aspects 1-4, further includes that the height based condition is associated with at least one of a range of MCS for the sidelink transmissions, a range of a number of subchannels used for the sidelink transmissions, an upper bound of sidelink retransmissions, or an upper bound of sidelink transmission power for the sidelink transmissions.
Aspect 6 is the method of any of aspects 1-5, further includes that the sidelink transmission parameters comprise a range based condition based on a range threshold, wherein the sidelink transmission parameters indicate for the UE to transmit sidelink transmissions using a first restriction in the sidelink transmission parameters to transmit a transport block for a UE service when the UE service range requirement is greater than or equal to the range threshold and to transmit the sidelink transmissions using a second message and a second restriction in the sidelink transmission parameters to transmit the transport block when the UE service range requirement is below the range threshold.
Aspect 7 is the method of any of aspects 1-6, further includes that the range based condition comprise limitations to at least one of a range of MCS for sidelink transmissions, a range of a number of subchannels used for sidelink transmissions, an upper bound of a number of sidelink retransmissions, or an upper bound of sidelink transmission power for the sidelink transmissions.
Aspect 8 is the method of any of aspects 1-7, further includes that the sidelink transmission parameters comprise a geographic area based condition, wherein the sidelink transmission parameters indicate for the UE to transmit sidelink transmissions using a first restriction in the sidelink transmission parameters to transmit a transport block for a UE service when the UE location is within the geographic area and to transmit the sidelink transmissions using a second message and a second restriction in the sidelink transmission parameters to transmit the transport block when the UE location is outside the geographic area.
Aspect 9 is the method of any of aspects 1-8, further includes that the geographic area based condition comprise limitations to at least one of a range of MCS for sidelink transmissions, a range of a number of subchannels used for the sidelink transmissions, an upper bound of a number of sidelink retransmissions, or an upper bound for sidelink transmission power.
Aspect 10 is an apparatus for wireless communication at a UE including at least one processor coupled to a memory and at least one transceiver, the at least one processor configured to implement any of Aspects 1-9.
Aspect 11 is an apparatus for wireless communication at a UE including means for implementing any of Aspects 1-9.
Aspect 12 is a computer-readable medium storing computer executable code, where the code when executed by a processor causes the processor to implement any of Aspects 1-9.
Aspect 13 is a method of wireless communication at a network entity comprising configuring sidelink transmission parameters based on at least one of a height of a UE, a UE service range, or an area of a UE location; providing a configuration of the sidelink transmission parameters based on at least one of the height of the UE, the UE service range, or the area of the UE location; and communicating based on the sidelink transmission parameters and at least one of the height of the UE, the UE service range, or the area of the UE location.
Aspect 14 is the method of aspect 13, further includes that the sidelink transmission parameters comprise a height based condition based on a height threshold, wherein the sidelink transmission parameters indicate for the UE to transmit sidelink transmissions using a first restriction in the sidelink transmission parameters to transmit a transport block when the height of the UE is greater than or equal to the height threshold and to transmit the sidelink transmissions using a second message and a second restriction in the sidelink transmission parameters to transmit the transport block when the height of the UE is below the height threshold.
Aspect 15 is the method of any of aspects 13 and 14, further includes that the sidelink transmissions comprise at least a BRID or a DAA signal.
Aspect 16 is the method of any of aspects 13-15, further includes that the height threshold is based at least on one of a sea level, a ground level, a height of a serving cell, or a reference point.
Aspect 17 is the method of any of aspects 13-16, further includes that the height based condition is associated with at least one of a range of MCS for the sidelink transmissions, a range of a number of subchannels used for the sidelink transmissions, an upper bound of sidelink retransmissions, or an upper bound of sidelink transmission power for the sidelink transmissions.
Aspect 18 is the method of any of aspects 13-17, further includes that the sidelink transmission parameters comprise a range based condition based on a range threshold, wherein the sidelink transmission parameters indicate for the UE to transmit sidelink transmissions using a first restriction in the sidelink transmission parameters to transmit a transport block for a UE service when the UE service range requirement is greater than or equal to the range threshold and to transmit the sidelink transmissions using a second message and a second restriction in the sidelink transmission parameters to transmit the transport block when the UE service range requirement is below the range threshold.
Aspect 19 is the method of any of aspects 13-18, further includes that the range based condition comprise limitations to at least one of a range of MCS for sidelink transmissions, a range of a number of subchannels used for sidelink transmissions, an upper bound of a number of sidelink retransmissions, or an upper bound of sidelink transmission power for the sidelink transmissions.
Aspect 20 is the method of any of aspects 13-19, further includes that the sidelink transmission parameters comprise a geographic area based condition, wherein the sidelink transmission parameters indicate for the UE to transmit sidelink transmissions using a first restriction in the sidelink transmission parameters to transmit a transport block for a UE service when the UE location is within the geographic area and to transmit the sidelink transmissions using a second message and a second restriction in the sidelink transmission parameters to transmit the transport block when the UE location is outside the geographic area.
Aspect 21 is the method of any of aspects 13-20, further includes that the geographic area based condition comprise limitations to at least one of a range of MCS for sidelink transmissions, a range of a number of subchannels used for the sidelink transmissions, an upper bound of a number of sidelink retransmissions, or an upper bound for sidelink transmission power.
Aspect 22 is an apparatus for wireless communication at a UE including at least one processor coupled to a memory and at least one transceiver, the at least one processor configured to implement any of Aspects 13-21.
Aspect 23 is an apparatus for wireless communication at a UE including means for implementing any of Aspects 13-21.
Aspect 24 is a computer-readable medium storing computer executable code, where the code when executed by a processor causes the processor to implement any of Aspects 13-21.

What is claimed is:

1. An apparatus for wireless communication at a user equipment (UE), comprising:
a memory; and
at least one processor coupled to the memory and, based at least in part on information stored in the memory, the at least one processor is configured to:
receive a configuration of sidelink transmission parameters based on at least one of a height of the UE, a UE service range, or an area of a UE location; and
communicate based on the sidelink transmission parameters and at least one of the height of the UE, the UE service range, or the area of the UE location.

2. The apparatus of claim 1, further comprising a transceiver coupled to the at least one processor.

3. The apparatus of claim 1, wherein the sidelink transmission parameters comprise a height based condition based on a height threshold, wherein the sidelink transmission parameters indicate for the UE to transmit sidelink transmissions using a first restriction in the sidelink transmission parameters to transmit a transport block when the height of the UE is greater than or equal to the height threshold and to transmit the sidelink transmissions using a second message and a second restriction in the sidelink transmission parameters to transmit the transport block when the height of the UE is below the height threshold.

4. The apparatus of claim 3, wherein the sidelink transmissions comprise at least a broadcast remote identifier (BRID) or a detect and avoid (DAA) signal.

5. The apparatus of claim 3, wherein the height threshold is based at least on one of a sea level, a ground level, a height of a serving cell, or a reference point.

6. The apparatus of claim 3, wherein the height based condition is associated with at least one of a range of modulation and coding scheme (MCS) for the sidelink transmissions, a range of a number of subchannels used for the sidelink transmissions, an upper bound of sidelink retransmissions, or an upper bound of sidelink transmission power for the sidelink transmissions.

7. The apparatus of claim 1, wherein the sidelink transmission parameters comprise a range based condition based on a range threshold, wherein the sidelink transmission parameters indicate for the UE to transmit sidelink transmissions using a first restriction in the sidelink transmission parameters to transmit a transport block for a UE service when the UE service range requirement is greater than or equal to the range threshold and to transmit the sidelink transmissions using a second message and a second restriction in the sidelink transmission parameters to transmit the transport block when the UE service range requirement is below the range threshold.

8. The apparatus of claim 7, wherein the range based condition comprise limitations to at least one of:
a range of modulation and coding scheme (MCS) for sidelink transmissions,
a range of a number of subchannels used for sidelink transmissions,
an upper bound of a number of sidelink retransmissions, or
an upper bound of sidelink transmission power for the sidelink transmissions.

9. The apparatus of claim 1, wherein the sidelink transmission parameters comprise a geographic area based condition, wherein the sidelink transmission parameters indicate for the UE to transmit sidelink transmissions using a first restriction in the sidelink transmission parameters to transmit a transport block for a UE service when the UE location is within the geographic area and to transmit the sidelink transmissions using a second message and a second restriction in the sidelink transmission parameters to transmit the transport block when the UE location is outside the geographic area.

10. The apparatus of claim 9, wherein the geographic area based condition comprise limitations to at least one of:
a range of modulation and coding scheme (MCS) for sidelink transmissions,
a range of a number of subchannels used for the sidelink transmissions,
an upper bound of a number of sidelink retransmissions, or
an upper bound for sidelink transmission power.

11. A method of wireless communication for a user equipment (UE), comprising:
receiving a configuration of sidelink transmission parameters based on at least one of a height of the UE, a UE service range, or an area of a UE location; and
communicating based on the sidelink transmission parameters and at least one of the height of the UE, the UE service range, or the area of the UE location.

12. The method of claim 11, wherein the sidelink transmission parameters comprise a height based condition based on a height threshold, wherein the sidelink transmission parameters indicate for the UE to transmit sidelink transmissions using a first restriction in the sidelink transmission parameters to transmit a transport block when the height of the UE is greater than or equal to the height threshold and to transmit the sidelink transmissions using a second message and a second restriction in the sidelink transmission parameters to transmit the transport block when the height of the UE is below the height threshold.

13. The method of claim 12, wherein the height based condition is associated with at least one of a range of modulation and coding scheme (MCS) for the sidelink transmissions, a range of a number of subchannels used for the sidelink transmissions, an upper bound of sidelink retransmissions, or an upper bound of sidelink transmission power for the sidelink transmissions.

14. The method of claim 11, wherein the sidelink transmission parameters comprise a range based condition based on a range threshold, wherein the sidelink transmission parameters indicate for the UE to transmit sidelink transmissions using a first restriction in the sidelink transmission parameters to transmit a transport block for a UE service when the UE service range requirement is greater than or equal to the range threshold and to transmit the sidelink transmissions using a second message and a second restriction in the sidelink transmission parameters to transmit the transport block when the UE service range requirement is below the range threshold.

15. The method of claim 11, wherein the sidelink transmission parameters comprise a geographic area based condition, wherein the sidelink transmission parameters indicate for the UE to transmit sidelink transmissions using a first restriction in the sidelink transmission parameters to transmit a transport block for a UE service when the UE location is within the geographic area and to transmit the sidelink transmissions using a second message and a second restriction in the sidelink transmission parameters to transmit the transport block when the UE location is outside the geographic area.

16. An apparatus for wireless communication at a network entity, comprising:
a memory; and
at least one processor coupled to the memory and, based at least in part on information stored in the memory, the at least one processor is configured to:
configure sidelink transmission parameters based on at least one of a height of a user equipment (UE), a UE service range, or an area of a UE location;
provide a configuration of the sidelink transmission parameters based on at least one of the height of the UE, the UE service range, or the area of the UE location; and
communicate based on the sidelink transmission parameters and at least one of the height of the UE, the UE service range, or the area of the UE location.

17. The apparatus of claim 16, further comprising a transceiver coupled to the at least one processor.

18. The apparatus of claim 16, wherein the sidelink transmission parameters comprise a height based condition based on a height threshold, wherein the sidelink transmission parameters indicate for the UE to transmit sidelink transmissions using a first restriction in the sidelink transmission parameters to transmit a transport block when the height of the UE is greater than or equal to the height threshold and to transmit the sidelink transmissions using a second message and a second restriction in the sidelink transmission parameters to transmit the transport block when the height of the UE is below the height threshold.

19. The apparatus of claim 18, wherein the sidelink transmissions comprise at least a broadcast remote identifier (BRID) or a detect and avoid (DAA) signal.

20. The apparatus of claim 18, wherein the height threshold is based at least on one of a sea level, a ground level, a height of a serving cell, or a reference point.

21. The apparatus of claim 18, wherein the height based condition is associated with at least one of a range of modulation and coding scheme (MCS) for the sidelink transmissions, a range of a number of subchannels used for the sidelink transmissions, an upper bound of sidelink retransmissions, or an upper bound of sidelink transmission power for the sidelink transmissions.

22. The apparatus of claim 16, wherein the sidelink transmission parameters comprise a range based condition based on a range threshold, wherein the sidelink transmission parameters indicate for the UE to transmit sidelink transmissions using a first restriction in the sidelink transmission parameters to transmit a transport block for a UE service when the UE service range requirement is greater than or equal to the range threshold and to transmit the sidelink transmissions using a second message and a second restriction in the sidelink transmission parameters to transmit the transport block when the UE service range requirement is below the range threshold.

23. The apparatus of claim 22, wherein the range based condition comprise limitations to at least one of:
a range of modulation and coding scheme (MCS) for sidelink transmissions,
a range of a number of subchannels used for sidelink transmissions,
an upper bound of a number of sidelink retransmissions, or
an upper bound of sidelink transmission power for the sidelink transmissions.

24. The apparatus of claim 16, wherein the sidelink transmission parameters comprise a geographic area based condition, wherein the sidelink transmission parameters indicate for the UE to transmit sidelink transmissions using a first restriction in the sidelink transmission parameters to transmit a transport block for a UE service when the UE location is within the geographic area and to transmit the sidelink transmissions using a second message and a second restriction in the sidelink transmission parameters to transmit the transport block when the UE location is outside the geographic area.

25. The apparatus of claim 24, wherein the geographic area based condition comprise limitations to at least one of:
a range of modulation and coding scheme (MCS) for sidelink transmissions,
a range of a number of subchannels used for the sidelink transmissions,
an upper bound of a number of sidelink retransmissions, or
an upper bound for sidelink transmission power.

26. A method of wireless communication for a network entity, comprising:
configuring sidelink transmission parameters based on at least one of a height of a user equipment (UE), a UE service range, or an area of a UE location;
providing a configuration of the sidelink transmission parameters based on at least one of the height of the UE, the UE service range, or the area of the UE location; and
communicating based on the sidelink transmission parameters and at least one of the height of the UE, the UE service range, or the area of the UE location.

27. The method of claim 26, wherein the sidelink transmission parameters comprise a height based condition based on a height threshold, wherein the sidelink transmission parameters indicate for the UE to transmit sidelink transmissions using a first restriction in the sidelink transmission parameters to transmit a transport block when the height of the UE is greater than or equal to the height threshold and to transmit the sidelink transmissions using a second message and a second restriction in the sidelink transmission parameters to transmit the transport block when the height of the UE is below the height threshold.

28. The method of claim 27, wherein the height based condition is associated with at least one of a range of modulation and coding scheme (MCS) for the sidelink transmissions, a range of a number of subchannels used for the sidelink transmissions, an upper bound of sidelink retransmissions, or an upper bound of sidelink transmission power for the sidelink transmissions.

29. The method of claim 26, wherein the sidelink transmission parameters comprise a range based condition based on a range threshold, wherein the sidelink transmission parameters indicate for the UE to transmit sidelink transmissions using a first restriction in the sidelink transmission parameters to transmit a transport block for a UE service when the UE service range requirement is greater than or equal to the range threshold and to transmit the sidelink transmissions using a second message and a second restriction in the sidelink transmission parameters to transmit the transport block when the UE service range requirement is below the range threshold.

30. The method of claim 26, wherein the sidelink transmission parameters comprise a geographic area based condition, wherein the sidelink transmission parameters indicate for the UE to transmit sidelink transmissions using a first restriction in the sidelink transmission parameters to transmit a transport block for a UE service when the UE location is within the geographic area and to transmit the sidelink transmissions using a second message and a second restriction in the sidelink transmission parameters to transmit the transport block when the UE location is outside the geographic area.
